(19) United States
(12) Patent Application Publication
(10) Pub. No.: US 2018/0182047 A1
(43) Pub. Date: Jun. 28, 2018

(54) OPERATION SUPPORT APPARATUS, OPERATION SUPPORT SYSTEM, AND INFORMATION PROCESSING APPARATUS

(71) Applicant: FUJI ELECTRIC CO., LTD., Kanagawa (JP)

(72) Inventors: Yoshio TANGE, Tokyo (JP); Satoshi KIRYU, Tokyo (JP)

(21) Appl. No.: 15/829,097

(22) Filed: Dec. 1, 2017

(30) Foreign Application Priority Data
Dec. 28, 2016 (JP) 2016-256236

(51) Int. Cl. G06Q 50/06; G06Q 10/06; G06Q 10/04; G06F 3/048; G06F 17/50

(52) U.S. Cl. CPC G06Q 50/06; G06Q 10/06315; G06F 17/50; G06F 3/048; G06Q 10/04

(57) ABSTRACT

An operation support apparatus includes: an input unit that inputs a demand-supply system model, facility-capacity information, and analysis condition information in which variables are defined; a logical formula generating unit that generates, based on the demand-supply system model, the facility-capacity information, and the analysis condition information, a relational logical formula; a depicting data generating unit that generates depicting data for depicting, in a coordinate system with the variables as respective coordinate axes, an area that satisfies the relational logical formula; a visualization library generating unit that generates a visualization library that includes the depicting data or a visualization library for generating the depicting data; and an online visualizing unit that depicts, based on the visualization library and performance data of the demand-supply system obtained from a measurement apparatus, the area and a performance point represented by the performance data in the coordinate system.

### BACKGROUND OF THE INVENTION

### 1. Field of the Invention

The present invention relates to an operation support apparatus, an operation support system, and an information processing apparatus.

### 2. Description of the Related Art

A technique for determining, depending on a demanded quantity of resources such as steam or cold energy demanded by a facility, quantities of the resources generated/supplied by a plurality of facilities such that consumed costs such as gas, heavy oil, or electric power are optimum is known in the related art.

Further, a technique for considering an efficient operation of a demand-supply system by visualizing a relationship between a total of costs of facilities that generate/supply resources (total cost) and a total demanded quantity of a facility that demands the resources is known in the related art (see Patent Document 1, for example). The relationship between the total cost and the total demanded quantity in the demand-supply system is visualized as an area that represents a range of the total cost and a range of the total demanded quantity that can be taken by the demand-supply system (which may be referred to as the “executable area” hereinafter).

Here, by visualizing an executable area of a demand-supply system and daily performances of a total cost and a total demanded quantity in the demand-supply system, operational consideration can be expected in consideration of the daily performances of operation of the demand-supply system.

An object in one aspect of the embodiments is to support operational consideration in consideration daily performances of a demand-supply system.

### RELATED-ART DOCUMENTS

### Patent Document

[Patent Document 1] Japanese Patent No. 5761476

### SUMMARY OF THE INVENTION

According to one embodiment, an operation support apparatus supports an operation of a demand-supply system. The demand-supply system includes a resource supplying facility configured to supply a resource, a resource demander facility configured to demand the resource supplied from the resource supplying facility, and a supply path of the resource. The operation support apparatus includes: an input unit configured to input a demand-supply system model of the demand-supply system, facility-capacity information that represents a facility capacity of the resource supplying facility and the supply path, and analysis condition information in which a plurality of variables to be analyzed with respect to the demand-supply system model and the facility-capacity information are defined; a logical formula generating unit configured to generate, based on the demand-supply system model, the facility-capacity information, and the analysis condition information input by the input unit, a relational logical formula that represents a relationship between the plurality of variables; a depicting data generating unit configured to generate, based on the relational logical formula generated by the logical formula generating unit, depicting data for depicting, in a coordinate system with the plurality of variables as respective coordinate axes, an area that satisfies the relational logical formula; a visualization library generating unit configured to generate a visualization library that includes the depicting data generated by the depicting data generating unit or a visualization library that includes the depicting data generating unit to generate the depicting data on demand; and an online visualizing unit configured to depict, based on the visualization library generated by the visualization library generating unit and performance data of the demand-supply system obtained from a measurement apparatus coupled to the operation support apparatus, the area and a performance point represented by the performance data in the coordinate system.

According to one aspect of the embodiments, it is possible to support operational consideration in consideration daily performances of a demand-supply system.

### BRIEF DESCRIPTION OF THE DRAWINGS

FIG. 1 is a block diagram illustrating an example of a configuration of an operation support system according to a first embodiment;

FIG. 2 is a schematic diagram illustrating a method executed by a support apparatus to streamline an operation of a demand-supply system;

FIG. 3 is a block diagram illustrating an example of a hardware configuration of a support apparatus and a measurement apparatus according to the first embodiment;

FIG. 4 is a block diagram illustrating an example of a functional configuration of the operation support system according to the first embodiment;

FIG. 5 is a diagram illustrating an example of a demand-supply system model;

FIG. 6 is a diagram illustrating an example of facility-capacity information;

FIG. 7 is a diagram illustrating an example of analysis condition information;

FIG. 8 is a flowchart illustrating an example of a process executed by an offline analyzing unit;

FIG. 9 is a diagram illustrating an example of a first mathematical formula set;

FIG. 10 is a diagram illustrating an example of a second mathematical formula set;

FIG. 11 is a diagram illustrating an example of a first-order predicate logic formula;

FIG. 12 is a diagram illustrating an example of a relational logical formula;

FIG. 13 is a diagram illustrating an example of a visualization library;

FIG. 14 is a flowchart illustrating an example of a process of generating the visualization library;

FIG. 15 is a diagram that describes an example of initial polygons;

FIG. 16 is a diagram that describes an example of true-false determination of each polygon vertex (first time);

FIG. 17 is a diagram that describes an example of a division of polygons;

FIG. 18 is a diagram that describes an example of true-false determination of each polygon vertex (second time);

FIG. 19 is a diagram that describes an example of deformation of polygons;

FIG. 20 is a diagram illustrating an example of polygon data;

FIG. 21 is a flowchart illustrating an example of a process executed by an online visualizing unit;

FIG. 22 is a diagram illustrating an example of an executable area;

FIG. 23 is a diagram illustrating another example of the executable area;

FIG. 24 is a diagram illustrating an example of the executable area and performance points;

FIG. 25 is a block diagram illustrating an example of a configuration of an operation support system according to a second embodiment;

FIG. 26 is a block diagram illustrating an example of a configuration of an operation support system according to a third embodiment.

### DETAILED DESCRIPTION OF THE PREFERRED EMBODIMENTS

In the following, embodiments of the present invention will be described in detail with reference to the accompanying drawings.

### First Embodiment

<System Configuration>

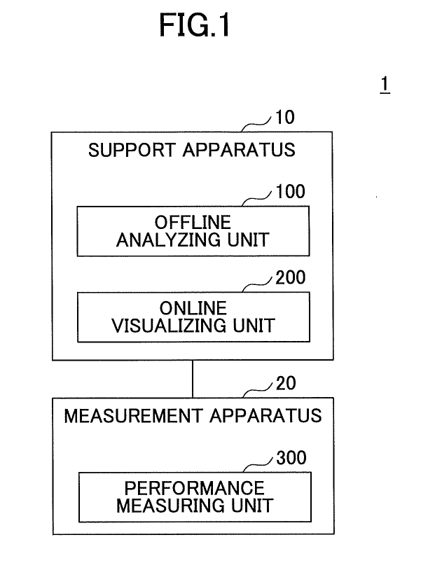

First, a system configuration of an operation support system 1 according to a first embodiment will be described with reference to FIG. 1. FIG. 1 is a block diagram illustrating an example of a configuration of the operation support system 1 according to the first embodiment.

As illustrated in FIG. 1, the operation support system 1 according to the first embodiment includes a support apparatus 10 and a measurement apparatus 20, and supports consideration of an efficient operation of a demand-supply system. Here, the demand-supply system may be a system that includes at least one resource supplying facility that generates and supplies a resource, at least one resource demander facility that demands the resource supplied from the at least one resource supplying facility, and at least one supply path for supplying the resource from the at least one resource supplying facility to the at least one resource demander facility.

A specific example of the demand-supply system may be an electric power system that includes at least one steam generating facility that consumes “gas” to produce and supply “steam”, at least one steam using facility that demands the “steam” and produces electric power or the like, and at least one steam transfer facility for supplying the steam, produced by the at least one steam generating facility, to the at least one steam using facility.

For example, the support apparatus 10 may be an information processing apparatus such as a computer, and provides information for supporting consideration of an efficient operation of the demand-supply system. The support apparatus 10 includes an offline analyzing unit 100 and an online visualizing unit 200.

For example, the offline analyzing unit 100 analyzes a relationship between a total of costs consumed by a demand-supply system (total cost) and a total of resources demanded by the demand-supply system (total demanded quantity). For example, the online visualizing unit 200 visualizes the relationship analyzed by the offline analyzing unit 100 and performances of the total cost and the total demanded quantity of the demand-supply system. Note that the relationship analyzed by the offline analyzing unit 100 (which is the relationship between the total cost and the total demanded quantity) is visualized as an area (as an executable area) that represents a range of the total cost that can be taken by the demand-supply system and a range of the total demanded quantity that can be taken by the demand-supply system.

A user who uses the support apparatus 10, such as a person in charge of an operation of the demand-supply system, becomes able to consider an efficient operation of the demand-supply system in consideration of the daily performances of the demand-supply system based on the relationship between the total cost and the total demanded quantity and the performances of the demand-supply system. Note that the efficient operation may be an operation that allows to produce a desired total demanded quantity and to reduce a total cost, for example.

For example, the measurement apparatus 20 may be a Programmable Logic Controller (PLC). The measurement apparatus 20 includes a performance measuring unit 300. For example, the performance measuring unit 300 measures performances of the total cost and the total demanded quantity of the demand-supply system. For example, the performances may be past records of the total cost consumed by the demand-supply system and of the total demanded quantity demanded by the demand-supply system.

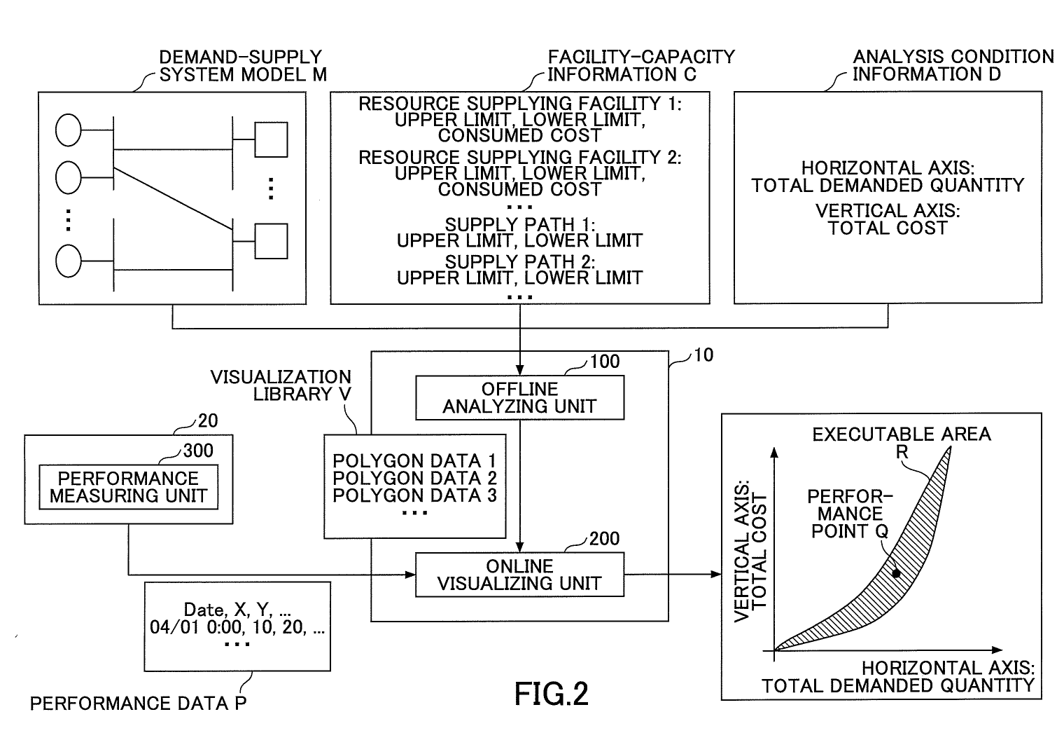

Here, according to the operation support system 1 of the first embodiment, an outline of a method executed by the support apparatus 10 to streamline an operation of a demand-supply system will be described with reference to FIG. 2. FIG. 2 is a schematic diagram illustrating a method executed by the support apparatus 10 to streamline the operation of the demand-supply system.

As illustrated in FIG. 2, the offline analyzing unit 100 inputs a demand-supply system model M, facility-capacity information C, and analysis condition information D.

The demand-supply system model M is information obtained by modeling a system configuration of the demand-supply system. The facility-capacity information C is information that represents facility capacities of resource supplying facilities and supply paths included in the demand-supply system. The analysis condition information D is information that represents variables to be the horizontal axis and the vertical axis of a coordinate system in which an area (which is an executable area R) visualized by the online visualizing unit 200 is to be depicted. That is, the analysis condition information D represents the variables to be analyzed with reference to the demand-supply system model M.

Note that in the following description, for example, the variable representing the horizontal axis is the “total demanded quantity” and the variable representing the vertical axis is the “total cost”.

The offline analyzing unit 100 generates a visualization library V based on the demand-supply system model M, the facility-capacity information C, and the analysis condition information D that are input. The visualization library V is information that includes polygon data that defines each of one or more polygons (polygonal areas) for depicting the executable area R. Note that in the following, each polygon is described as a square or triangle area, for example.

The online visualizing unit 200 displays the executable area R by depicting the polygons, defined by the polygon data included in the visualization library V, in the coordinate system with the “total demanded quantity” and the “total cost” as the horizontal axis and the vertical axis, respectively. Further, the online visualizing unit 200 displays performance point(s) Q by depicting, in the same coordinate system, performance data P measured by the performance measuring unit 300 of the measurement apparatus 20 during an operation of the demand-supply system (that is, when online). The performance measuring unit 300 measures the performance data P corresponding to the variables represented by the analysis condition information D (which are the “total demanded quantity” and the “total cost”).

In this way, a user of the support apparatus 10 becomes able to consider an efficient operation of the demand-supply system with reference to the executable area R and the performance point(s) Q displayed on the support apparatus 10. In other words, the user of the support apparatus 10 becomes able to consult the executable area R, which represents an executable range by the demand-supply system, and the performance points Q, which represent the daily performances of the demand-supply system, to consider the operation in consideration of the performances of operation.

Further, using the visualization library V, the support apparatus 10 displays (visualizes) the executable area R by depicting the polygons. Thereby, when displaying an executable area R, the support apparatus 10 can promptly display the executable area R without executing process that require time such as generating a first-order predicate logic formula and a quantifier elimination method. Hence, the support apparatus 10 can visualize the executable area R at high speed.

Note that the horizontal axis and the vertical axis of the analysis condition information D are not limited to the “total demanded quantity” and the “total cost”. Any suitable variables in the demand-supply system may be set to the horizontal axis and the vertical axis of the analysis condition information D. For example, a “total consumed energy”, a “total quantity of emitted CO₂”, a “consumed cost of a specific resource supplying facility”, a “demanded quantity of a specific resource demander facility” may be set to the horizontal axis or the vertical axis of the analysis condition information D.

<Hardware Configuration>

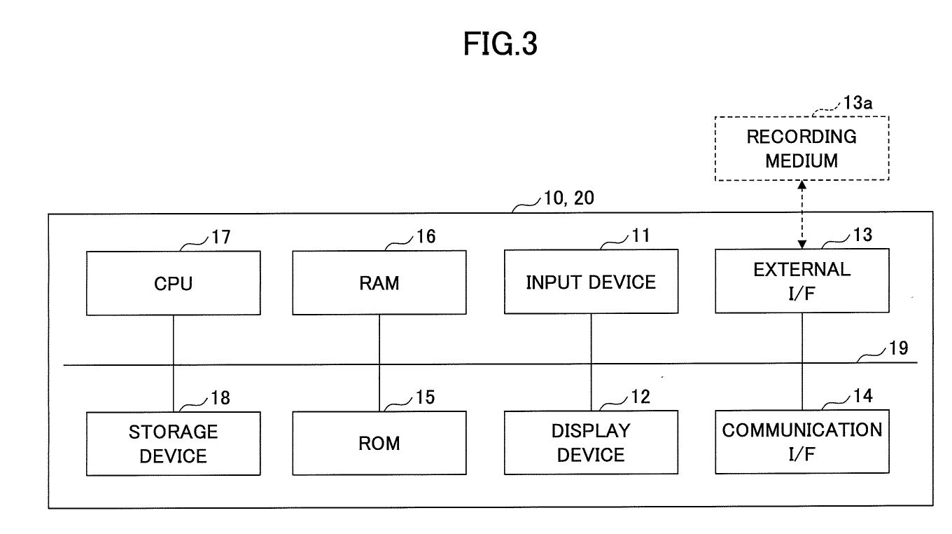

Next, a hardware configuration of the support apparatus 10 and the measurement apparatus 20 according to the first embodiment will be described with reference to FIG. 3. FIG. 3 is a block diagram illustrating an example of the hardware configuration of the support apparatus 10 and the measurement apparatus 20 according to the first embodiment. Because the support apparatus 10 and the measurement apparatus 20 have a similar hardware configuration, the hardware configuration of the support apparatus 10 will be mainly described here.

As illustrated in FIG. 3, the support apparatus 10 according to the first embodiment includes an input device 11, a display device 12, an external I/F 13, a communication I/F 14, a Read Only Memory (ROM) 15, a Random Access Memory (RAM) 16, a Central Processing Unit (CPU) 17, and a storage device 18. These hardware elements are coupled with each other via a bus 19.

For example, the input device 11 includes a keyboard, a mouse, a touch panel, various buttons, and the like. The user can use the input device 11 to input various operations to the support apparatus 10. The display device 12 includes a display and the like to display result of various processes by the support apparatus 10, for example. Note that the measurement apparatus 20 is not required to have both the input device 11 and the display device 12.

The external I/F 13 is an interface with an external apparatus. The external apparatus may be a recording medium 13a or the like. The support apparatus 10 can read information (data) from the recording medium 13a and write information (data) on the recording medium 13a through the external I/F 13. For example, the recording medium 13a may be a medium such as a Compact Disk (CD), a Digital Versatile Disk (DVD), a SD memory card, or a Universal Serial Bus (USB) memory.

The communication I/F 14 is an interface for the support apparatus 10 to perform data communication with another apparatus such as the measurement apparatus 20, for example.

The ROM 15 is a non-volatile semiconductor memory that can hold (store) one or more programs and/or data even when a power source is powered off. The RAM 16 is a volatile semiconductor memory that temporarily holds (stores) one or more programs and/or data. The CPU 17 is an arithmetic device that reads, from the ROM 15 or the storage device 18, for example, the program(s) and/or the data onto the RAM 16 to execute various kinds of processes.

The storage device 18 is a non-volatile storage memory that stores programs and/or data such as a Hard Disk Drive (HDD) or a Solid State Drive (SDD), for example. The programs and/or data stored in the storage device 18 may include at least one program that actualizes the embodiment, an operating system (OS), which is basic software, and various application programs that provides various functions in the OS, and so on.

The support apparatus 10 and the measurement apparatus 20 according to the first embodiment have the hardware configuration as illustrated in FIG. 3 to actualize various processes, which will be described later below.

<Functional Configuration>

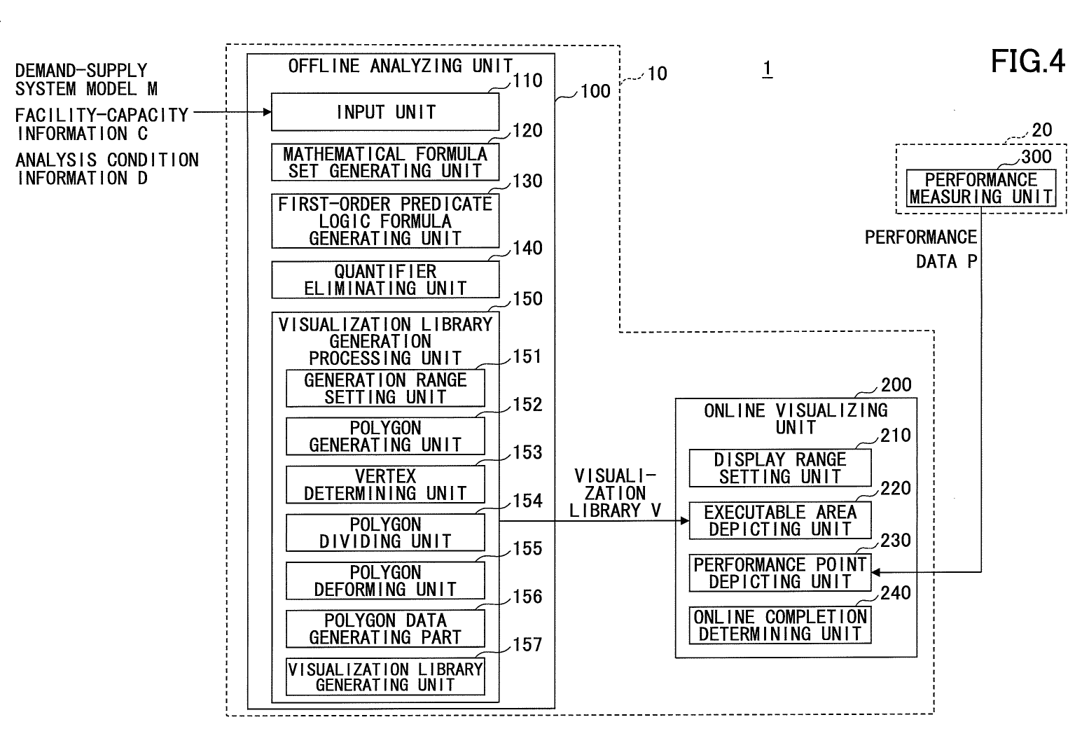

Next, a functional configuration of the operation support system 1 according to the first embodiment will be described with reference to FIG. 4. FIG. 4 is a block diagram illustrating an example of the functional configuration of the operation support system 1 according to the first embodiment.

As illustrated in FIG. 4, the support apparatus 10 according to the first embodiment includes an offline analyzing unit 100 and an online visualizing unit 200. These functional units (elements) are actualized by a process that at least one program, installed in the support apparatus 10, causes the CPU 17 to execute.

The offline analyzing unit 100 includes an input unit 110, a mathematical formula set generating unit 120, a first-order predicate logic formula generating unit 130, a quantifier eliminating unit 140, and a visualization library generation processing unit 150.

The input unit 110 inputs a demand-supply system model M, facility-capacity information C, and analysis condition information D.

The mathematical formula set generating unit 120 generates a first mathematical formula set and a second mathematical formula set based on the demand-supply system model M and the facility-capacity information C input by the input unit 110. The first mathematical formula set is a set (group) of formulas that represent an objective variable in an optimization problem and definitions relating to the objective variable. Further, the second mathematical formula set is a set (group) of formulas that represent constraint conditions in the optimization problem. In other words, the mathematical formula set generating unit 120 may generate, based on the demand-supply system model M, the facility-capacity information C, and the analysis condition information D input from the input unit 110, a mathematical formula set that includes a plurality of mathematical formulas that represent the objective variable and the constraint conditions in the optimization problem of the demand-supply system.

The first-order predicate logic formula generating unit 130 generates a first-order predicate logic formula based on the first mathematical formula set and the second mathematical formula set generated by the mathematical formula set generating unit 120.

Using a quantifier elimination method, the quantifier eliminating unit 140 generates, based on the first-order predicate logic formula generated by the first-order predicate logic formula generating unit 130 and based on the analysis condition information D input by the input unit 110, a relational logical formula that represents a logical formula representing a relationship between a total demanded quantity and a total cost.

The visualization library generation processing unit 150 generates a visualization library V based on the relational logical formula generated by the quantifier eliminating unit 140. Here, the visualization library generation processing unit 150 includes a generation range setting unit 151, a polygon generating unit 152, a vertex determining unit 153, a polygon dividing unit 154, a polygon deforming unit 155, a polygon data generating part 156, and a visualization library generating unit 157.

The generation range setting unit 151 sets a range in which one or more polygons for depicting an executable area R are generated. For example, the range, in which the polygons for depicting the executable area R are generated, may be, in a coordinate system where the horizontal axis and the vertical axis respectively correspond to the “total demanded quantity” and the “total cost”, the ranges of the total demanded quantity and the total cost that include the executable area R of the demand-supply system.

The polygon generating unit 152 generates polygons (initial polygons) in the range set by the generation range setting unit 151.

The vertex determining unit 153 determines, for the coordinates of each vertex of the polygons, whether a value of the relational logical formula generated by the quantifier elimination unit 140 is true or false. That is, the vertex determining unit 153 determines, for the coordinates of each vertex of the initial polygons generated by the polygon generating unit 152 or for the coordinates of each vertex of polygons divided by the polygon dividing unit 154, whether the value of the relational logical formula is true or false.

The polygon dividing unit 154 divides each polygon in accordance with the value (true or false) of each vertex determined by the vertex determining unit 153. In a case where a division of polygons has been performed a predetermined number of times by the polygon dividing unit 154, the polygon deforming unit 155 deforms each polygon in accordance with the value of each vertex determined by the vertex determining unit 153. The polygon data generating unit 156 generates polygon data that represents coordinates of each vertex of the polygons deformed by the polygon deforming unit 155.

The visualization library generating unit 157 generates a visualization library V that includes the polygon data generated by the polygon data generating unit 156.

The online visualizing unit 200 includes a display range setting unit 210, an executable area depicting unit 220, a performance point depicting unit 230, and an online completion determining unit 240.

The display range setting unit 210 sets a range (display range) in which an executable area R is displayed. That is, within the coordinate system that includes the executable area R depicted by the executable area depicting unit 220, the display range setting unit 210 sets a range to be displayed on the display device 12.

The executable area depicting unit 220 depicts the executable area R based on the visualization library V generated by the visualization library generating unit 157. That is, for example, the executable area depicting unit 220 depicts, in the coordinate system where the horizontal axis and the vertical axis respectively correspond to the “total demanded quantity” and the “total cost”, one or more polygons defined by polygon data PD included in the visualization library V.

The performance point depicting unit 230 depicts one or more performance points Q based on performance data P measured by the performance measuring unit 300 of the measurement apparatus 20 during an operation of the demand-supply system (that is, when online). That is, for example, the performance point depicting unit 230 depicts the performance points Q, represented by the performance data P, in the coordinate system in which the horizontal axis and the vertical axis respectively correspond to the “total demanded quantity” and the “total cost”.

The online completion determining unit 240 determines whether to complete an online process. For example, when the user performs an operation to complete the online process, the online completion determining unit 240 determines to complete the online process.

As illustrated in FIG. 4, the measurement apparatus 20 according to the first embodiment includes the performance measuring unit 300. This functional unit (element) may be actualized by a process that at least one program, installed in the measurement apparatus 20, causes the CPU 17 to execute. The performance measuring unit 300 measures each device included in a demand-supply system (such as a resource supplying facility, a resource demander facility, and a supply path) to obtain performance data P that represents performances of a total cost and a total demanded quantity of the demand-supply system, for example.

Here, specific examples of the demand-supply system model M, the facility-capacity information C, and the analysis condition information D that are input to the offline analyzing unit 100 will be described.

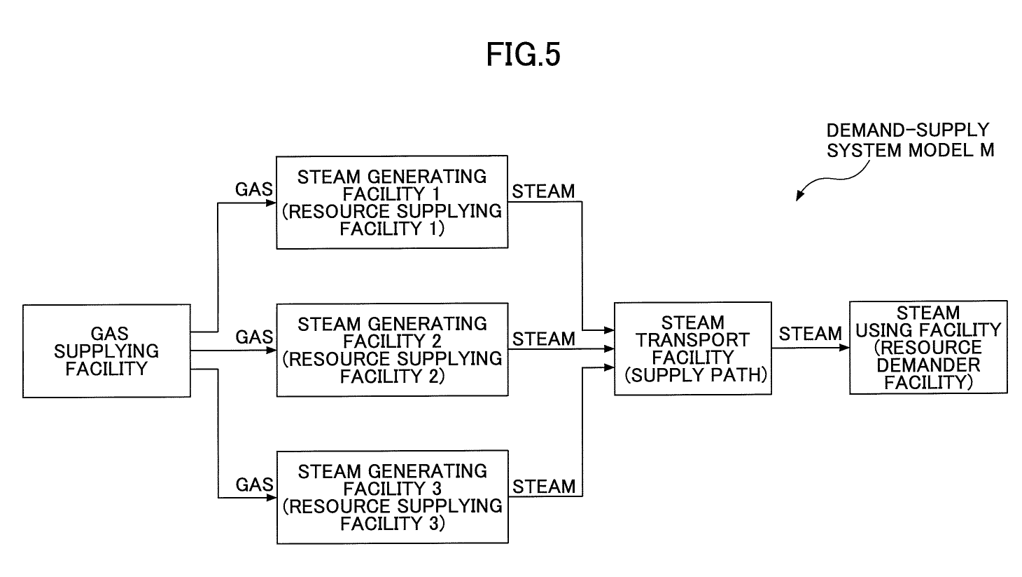

First, a specific example of the demand-supply system model M will be described with reference to FIG. 5. FIG. 5 is a diagram illustrating an example of the demand-supply system model M.

The demand-supply system model M illustrated in FIG. 5 causes each of steam generating facilities 1 to 3 to use gas supplied from a gas supplying facility as a fuel and to generate steam. Then, the demand-supply system model M causes a steam transport facility to supply the steam to a steam using facility, in which the steam is demanded.

Here, each of the steam generating facilities 1 to 3 is a “resource supplying facility”, the steam using facility is a “resource demander facility”, and the steam transport facility is a “supply path”. Further, the gas consumed, in each of the steam generating facilities 1 to 3, as the fuel is a “cost”, and the steam, supplied from each of the steam generating facilities 1 to 3, is a “resource”. It should be noted that although one resource demander facility is included in the demand-supply system model M in the example illustrated in FIG. 5, the number of resource demander facilities is not limited to one. The demand-supply system model M may have a plurality of resource demander facilities.

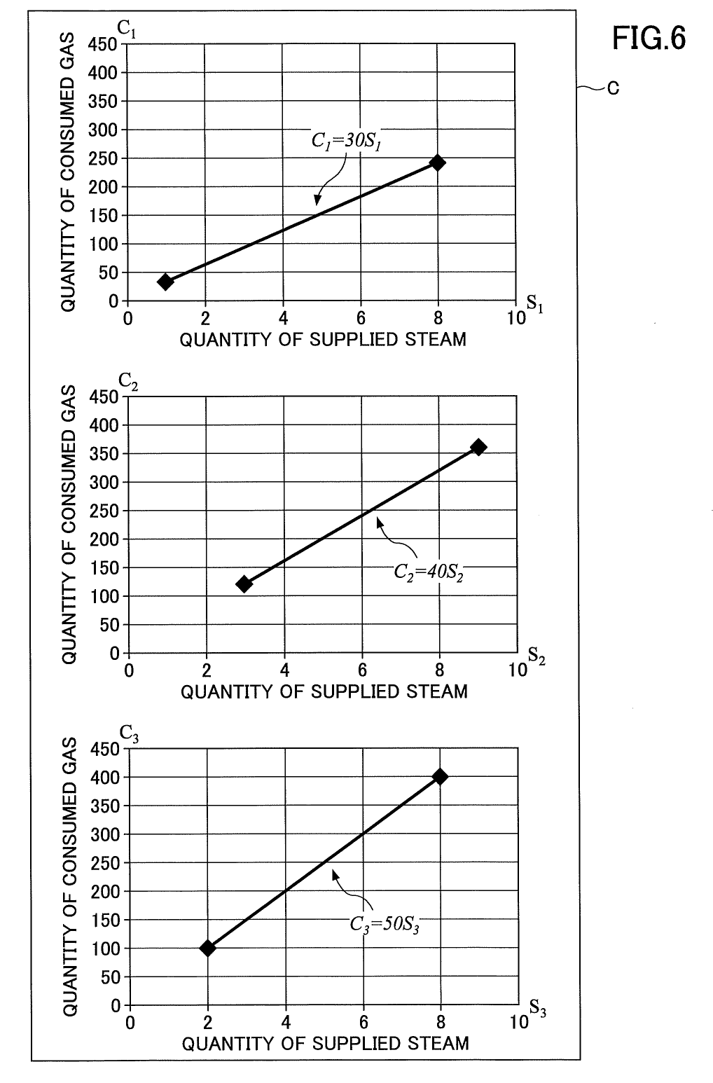

Next, a specific example of the facility-capacity information C corresponding to the demand-supply system model M will be describe with reference to FIG. 6. FIG. 6 is a diagram illustrating an example of the facility-capacity information C.

The facility-capacity information C illustrated in FIG. 6 is information that represents properties and constraint conditions of the resource supplying facilities 1 to 3. That is, a relationship between a consumed cost (quantity of consumed gas) C₁ and a supplied quantity (quantity of supplied steam) S₁ of the resource supplying facility 1 can be represented by “C₁=30S₁”. Further, constraint conditions of the resource supplying facility 1 (the lower limit constraint and the upper limit constraint) can be represented by “S₁≥1” and “S₁≥8”.

Similarly, a relationship between a consumed cost (quantity of consumed gas) C₂ and a supplied quantity (quantity of supplied steam) S₂ of the resource supplying facility 2 can be represented by “C₂=40S₂”. Further, constraint conditions of the resource supplying facility 2 (the lower limit constraint and the upper limit constraint) can be represented by “S₂≥3” and “S₂≤9”.

Similarly, a relationship between a consumed cost (quantity of consumed gas) C₃ and a supplied quantity (quantity of supplied steam) S₃ of the resource supplying facility 3 can be represented by “C₃=50S₃”. Further, constraint conditions of the resource supplying facility 3 (the lower limit constraint and the upper limit constraint) can be represented by “S₃≥2” and “S₃≤8”.

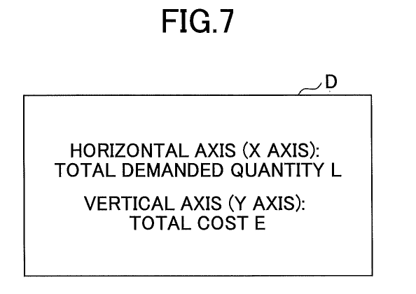

Next, a specific example of the analysis condition information D will be described with reference to FIG. 7. FIG. 7 is a diagram illustrating an example of the analysis condition information D.

The analysis condition information D illustrated in FIG. 7 is information that defines a variable representing a horizontal axis (X axis) and a variable representing a vertical axis (Y axis) of a coordinate system for depicting an executable range R. In the analysis condition information D illustrated in FIG. 7, the variable “L” representing a total demanded quantity is defined as the horizontal axis (X axis) and the variable “E” representing a total cost is defined as the vertical axis (Y axis).

Note that the demand-supply system model M, the facility-capacity information C, and the analysis condition information D may be stored in the storage device 18 of the support apparatus 10, for example. Note that the demand-supply system model M, the facility-capacity information C, and the analysis condition information D may be stored in the recording medium 13a or the like, for example. The demand-supply system model M, the facility-capacity information C, and the analysis condition information D are created by a user through the input device 11.

The demand-supply system model M, the facility-capacity information C, and the analysis condition information D may be obtained from another device via the communication I/F 14.

Although the variable representing the X axis and the variable representing the Y axis are defined in the analysis condition information D in the example illustrated in FIG. 7, the analysis condition information D is not limited to this. A variable representing a Z axis may further be defined in the analysis condition information D, for example. More generally, any number of variables may be defined for the analysis condition information D.

<Details of Processes>

Next, details of processes of the operation support system 1 according to the first embodiment will be described.

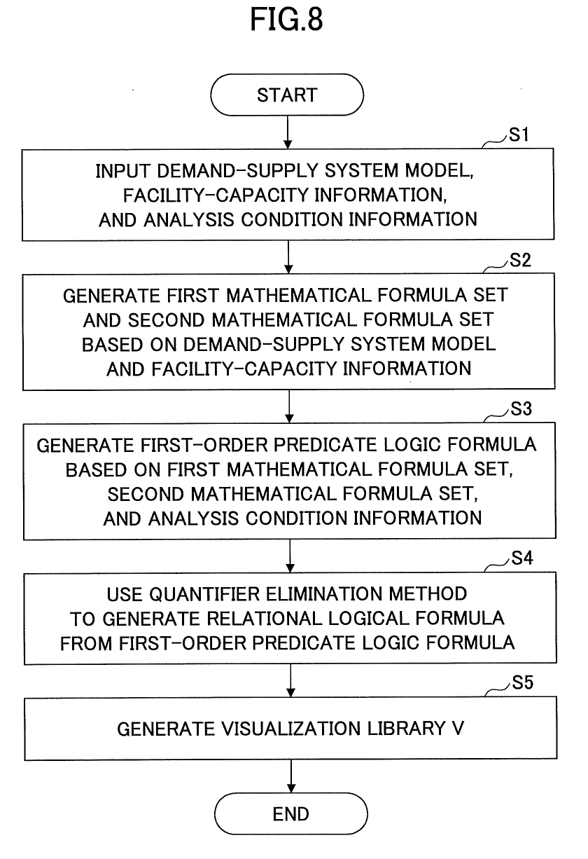

First, a process executed by the offline analyzing unit 100 to generate a visualization library V will be described with reference to FIG. 8. FIG. 8 is a flowchart illustrating an example of the process executed by the offline analyzing unit 100.

First, the input unit 110 inputs a demand-supply system model M, facility-capacity information C, and analysis condition information D in step S1.

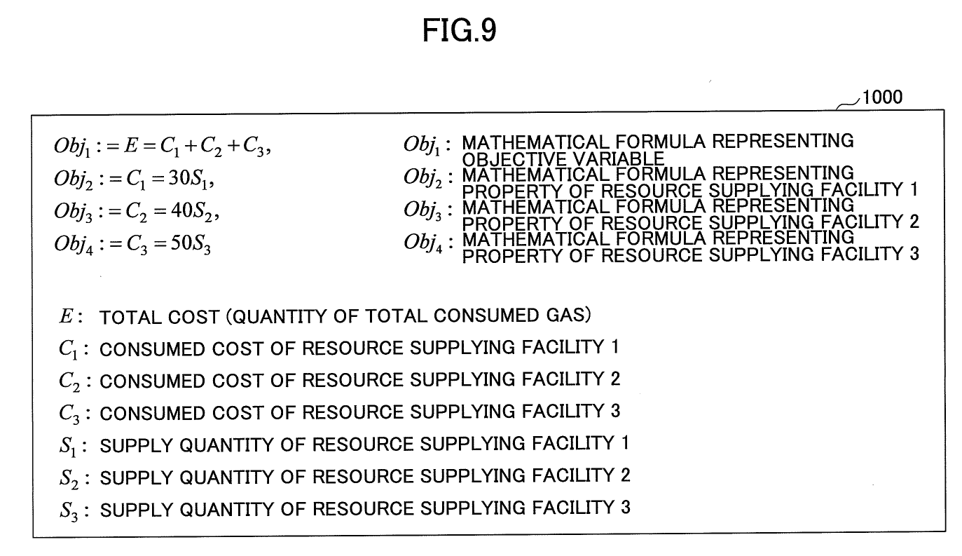

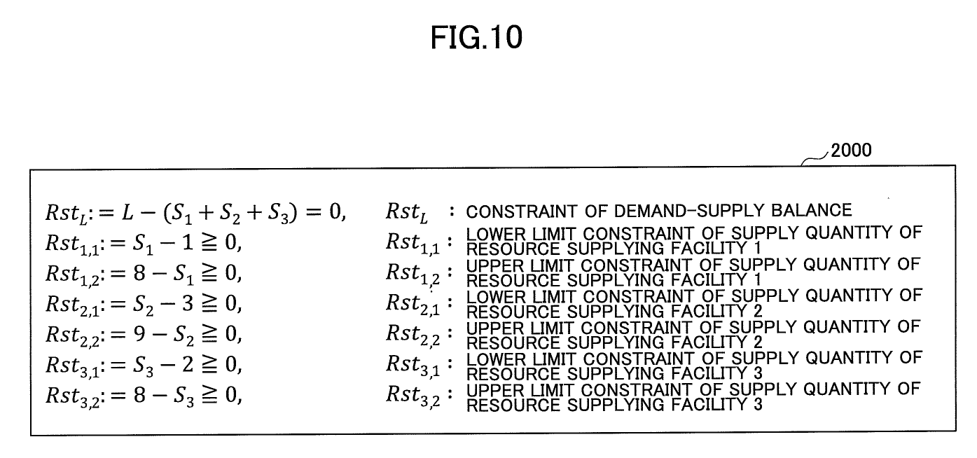

Next, in step S2, the mathematical formula set generating unit 120 generates a first mathematical formula set and a second mathematical formula set based on the demand-supply system model M and the facility-capacity information C input by the input unit 110. That is, the mathematical formula set generating unit 120 generates the first mathematical formula set 1000 illustrated in FIG. 9 and the second mathematical formula set 2000 illustrated in FIG. 10 based on the demand-supply system model M illustrated in FIG. 5 and the facility-capacity information C illustrated in FIG. 6. Note that the mathematical formula set generating unit 120 can generate the first mathematical formula set and the second mathematical formula set by using a method disclosed in Japanese Patent No. 5761476, for example.

The first mathematical formula set 1000 illustrated in FIG. 9 is generated by defining a mathematical formula Obj₁ that represents an objective variable, mathematical formulas Obj₂ to Obj₄ that represent respective properties of the resource supplying facilities 1 to 3. Here, for the Obj₁, a formula “E=C₁+C₂+C₃” that represents a relationship between a total cost E of the demand-supply system and consumed costs C₁ to C₃ of the respective resource supplying facilities 1 to 3 is defined. Further, for the Obj₂, a formula “C₁=30S₁” that represents a relationship between the consumed cost C₁ a supply quantity S₁ of the resource supplying facility 1 and is defined. Similarly, for the Obj₃ and Obj₄, formulas “C₂40S₂” and “C₃=50S₃” are defined.

The second mathematical formula set 2000 illustrated in FIG. 10 is generated by defining formulas RSt_{L}, Rst_{1,1}, Rst_{1,2}, Rst_{2,1}, RSt_{2,2}, RSt_{3,1}, and Rst_{3,2} that represent constraint conditions. Here, for the Rst_{L}, a constraint condition “L−(S₁+S₂+S₃)=0” that represents a demand-supply balance of a total demanded quantity L of the demand-supply system is defined. Further, for the Rst_{1,1}, “S₁−1≥0” is defined as a lower limit constraint of the supply quantity of the resource supplying facility 1. Similarly, for the Rst_{1,2}, “8−S₂≥0” is defined as an upper limit constraint of the supply quantity of the resource supplying facility 1. Rst_{2,1}, Rst_{2,2}, Rst_{3,1}, and Rst_{3,2} are similarly defined as illustrated in FIG. 10.

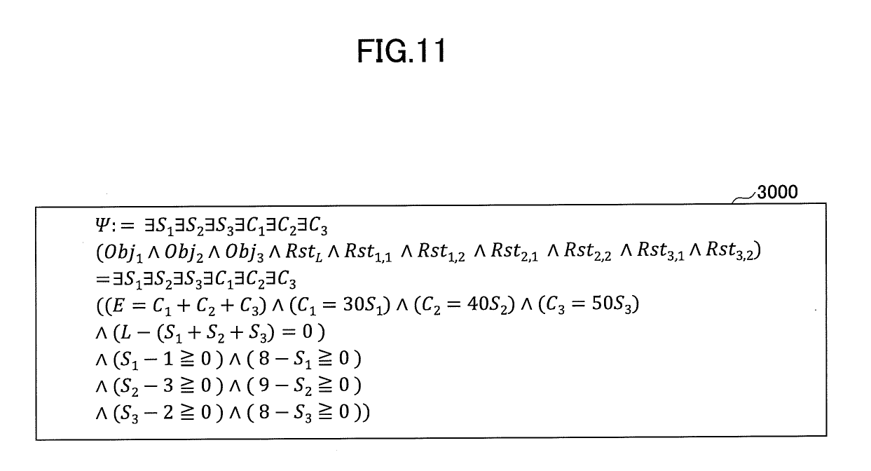

Next, in step S3, the first-order predicate logic formula generating unit 130 generates a first-order predicate logic formula based on the first mathematical formula set and the second mathematical formula set generated by the mathematical formula set generating unit 120 and based on the analysis condition information D input by the input unit 110. That is, the first-order predicate logic formula generating unit 130 generates the first-order predicate logic formula 3000 illustrated in FIG. 11 based on the first mathematical formula set 1000 and illustrated in FIG. 9 the second mathematical formula set 2000 illustrated in FIG. 10 and based on the analysis condition information D illustrated in FIG. 7. When generating the first-order predicate logic formula 3000, the first-order predicate logic formula generating unit 130 gives an existential quantifier (H) to quantifiers except for the two variables L and E designated in FIG. 7 among the variables that are expressed in the first mathematical formula set 1000 and the second mathematical formula set 2000. Note that the first-order predicate logic formula generating unit 130 can generate the first-order predicate logic formula by using a method disclosed in Japanese Patent No. 5761476, for example.

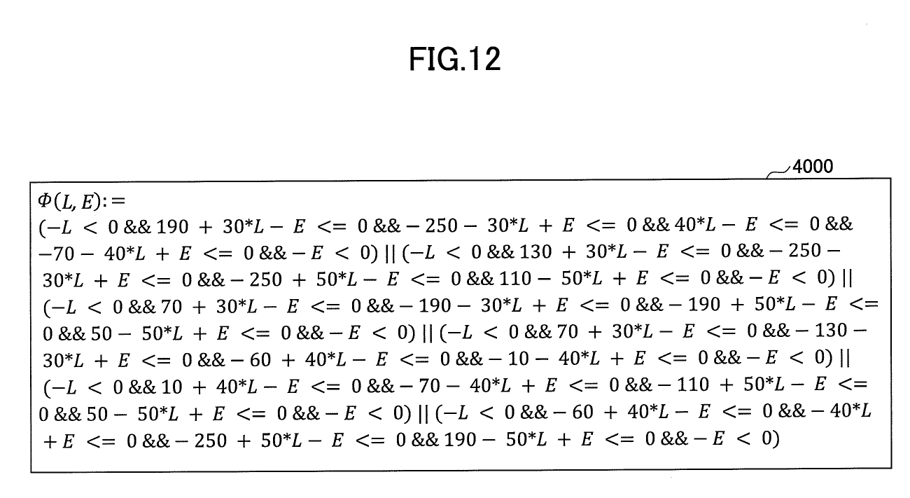

Next, in step S4, the quantifier eliminating unit 140 generates, based on the first-order predicate logic formula generated by the first-order predicate logic formula generating unit 130, a relational logical formula that represents a logical formula that represents a relationship between a total demanded quantity and a total cost by using a quantifier elimination method. That is, the quantifier eliminating unit 140 generates a relational logical formula 4000 illustrated in FIG. 12 based on the first-order predicate logic formula 3000 illustrated in FIG. 3000 illustrated in FIG. 11. The relational logical formula 4000 illustrated in FIG. 12 is a logical formula that represents a relationship between the variable “total demanded quantity L” representing the horizontal axis and the variable “total cost E” representing the vertical axis. Note that the quantifier eliminating unit 140 can generate the relational logical formula by using a method disclosed in Japanese Patent No. 5761476, for example.

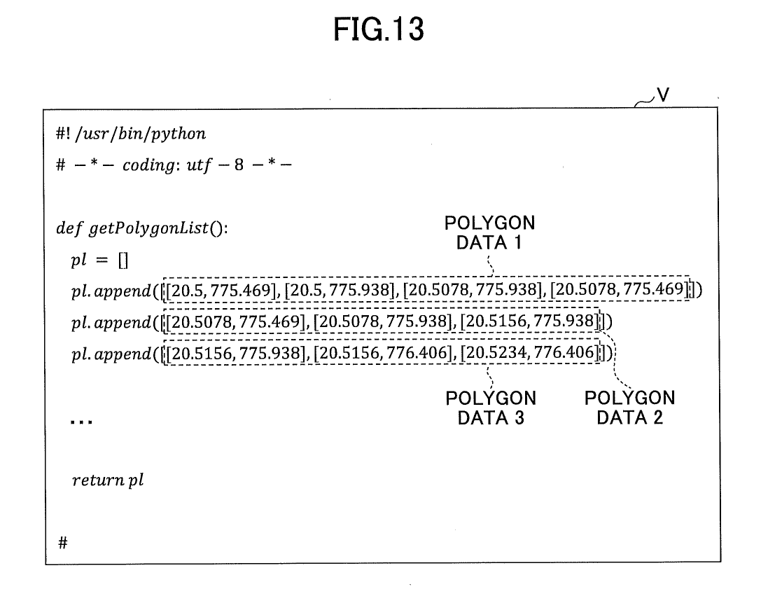

Next, in step S5, the visualization library generation processing unit 150 generates a visualization library V based on the relational logical formula generated by the quantifier eliminating unit 140. That is, for example, the visualization library generation processing unit 150 generates the visualization library V illustrated in FIG. 13 based on the relational logical formula 4000 illustrated in FIG. 12. For example, the visualization library V illustrated in FIG. 13 is described by Python and includes a plurality of sets of polygon data such as polygon data 1, polygon data 2, and polygon data 3 that represent coordinates of each vertex of polygons for depicting an executable area R.

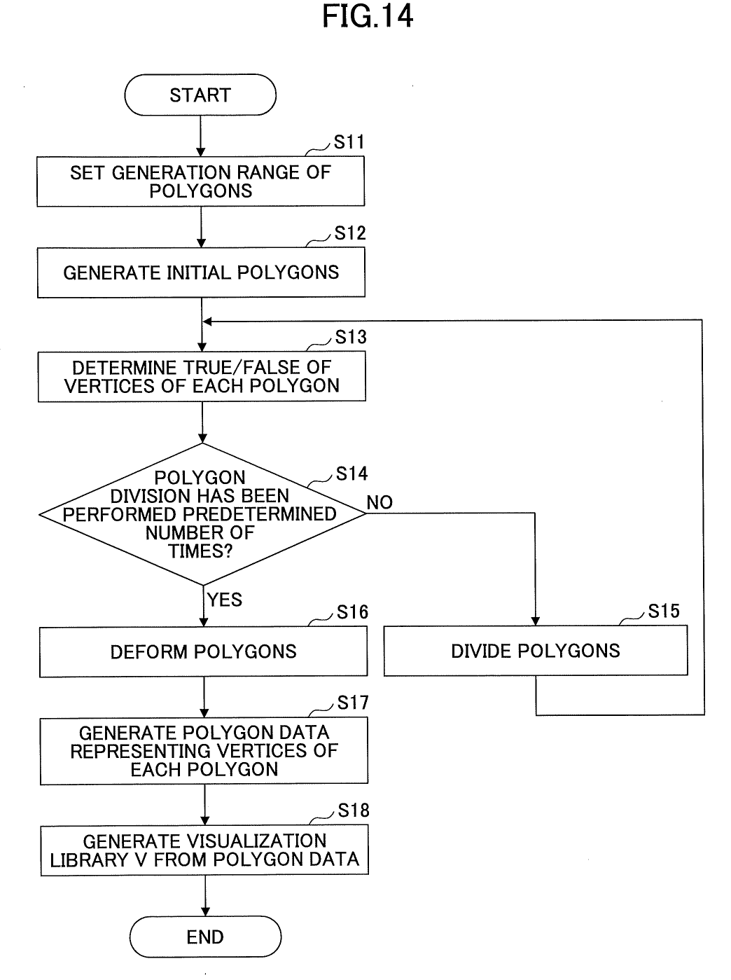

Here, details of a process executed by the visualization library generation processing unit to generate a visualization library V will be described with reference to FIG. 14. FIG. 14 is a flowchart illustrating an example of a process of generating the visualization library V. In the following, as an example, a case will be described where a visualization library V for depicting an executable area R on a coordinate system where the total demanded quantity L is in a range of from 0 to 5 and the total cost E is in a range of from 0 to 5 is generated.

First, in step S11, the generation range setting unit 151 sets a range in which polygons for depicting an executable area R are generated. That is, for example, the generation range setting unit 151 sets, as the range for depicting the executable area R, a range of the total demanded quantity L that is the horizontal axis and a range of the total cost E that is the vertical axis.

Note that the range of the total demanded quantity L, which is the horizontal axis, and the range of the total cost E, which is the vertical axis, may be set by a user setting desired ranges. For example, the user may set these ranges through the input device 11.

For example, the range of the total demanded quantity L, which is the horizontal axis, and the range of the total cost E, which is the vertical axis, may be set based on the relational logical formula 4000 illustrated in FIG. 12 such that the range of the total demanded quantity L and the range of the total cost E include the executable area R. In the following description, the range of from “1” to “4” is set as the range of the total demanded quantity L, and the range of from “1” to “4” is set as the range of the total cost E.

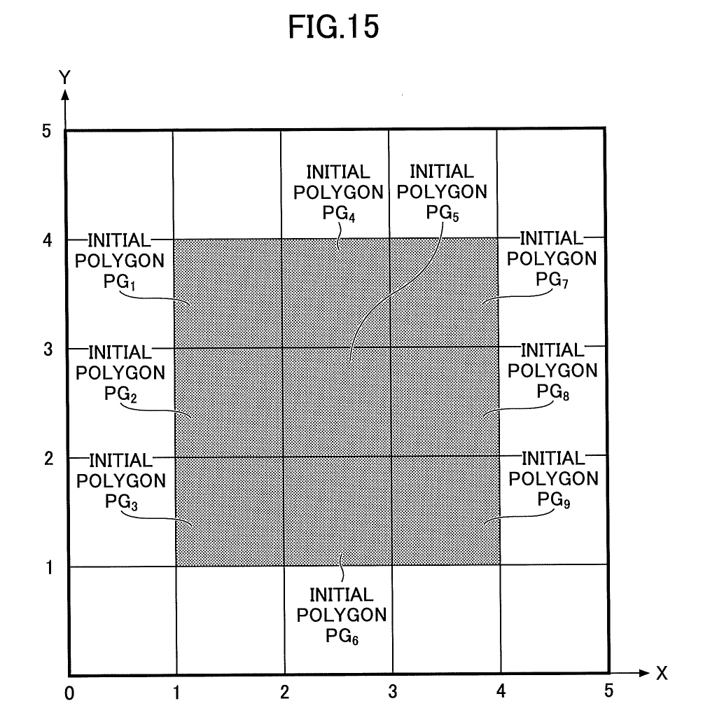

Next, in step S12, the polygon generating unit 152 generates polygons (initial polygons) in the range set by the generation range setting unit 151. That is, as illustrated in FIG. 15, the polygon generating unit 152 generates polygons (initial polygons) PG₁ to PG₉ of 1×1 within the range of from “1” to “4” of the total demanded quantity L and the range of from “1” to “4” of the total cost E.

Note that coordinates of respective vertices of the polygon PG₁ are (1,4), (1,3), (2,3), and (2,4). Further, the coordinates of respective vertices of the polygon PG₂ are (1,3), (1,2), (2,2), and (2,3). Similarly, coordinates are defined for four vertices of each of the polygons PG₃ to PG₉.

Next, in step S13, the vertex determining unit 153 determines, for the coordinates of each vertex of the polygons, whether a value of the relational logical formula Φ(L,E) generated by the quantifier elimination unit 140 is true or false.

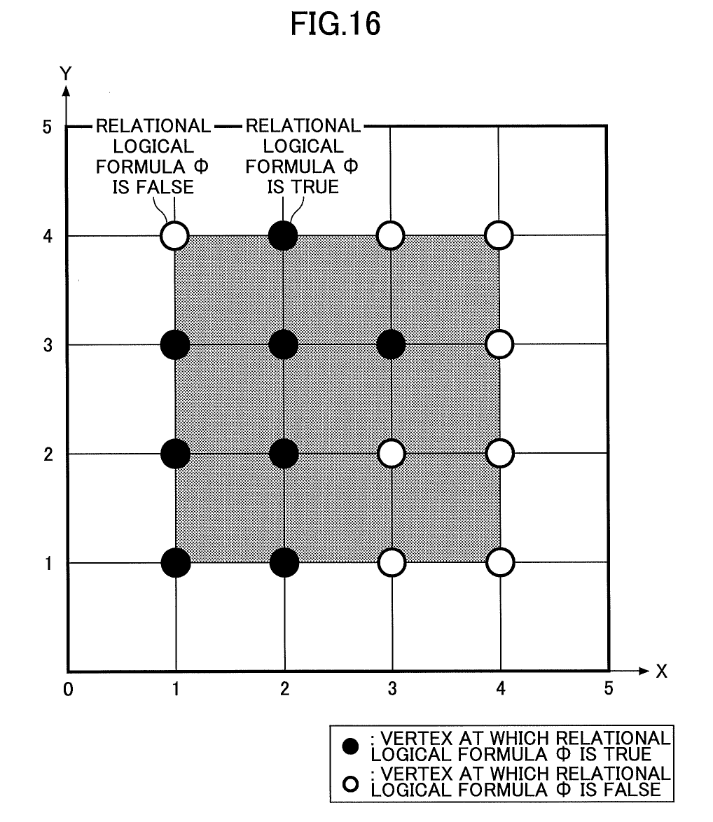

That is, for example, as illustrated in FIG. 16, the vertex determining unit 153 determines whether the value of the relational logical formula Φ(1,4) at the vertex (1,4) of the polygon PG₁ is true or false. Similarly, for example, as illustrated in FIG. 16, the vertex determining unit 153 determines whether the value of the relational logical formula Φ(2,4) at the vertex (2,4) of the polygon PG₁ is true or false.

In this way, the vertex determining unit 153 determines whether a value of the relational logical formula Φ(L,E) at the coordinates of each vertex of each of the polygons PG₁ to PG₉ is true or false.

Next, in step S14, the visualization library generation processing unit 150 determines whether the polygon dividing unit 154 has performed a polygon division for a predetermined number of times.

In a case where the visualization library generation processing unit 150 does not determine that a polygon division has been performed for the predetermined number of times (NO in step S14), the polygon dividing unit 154 divides in step S15 each polygon in accordance with the value (true or false) of each vertex determined by the vertex determining unit 153.

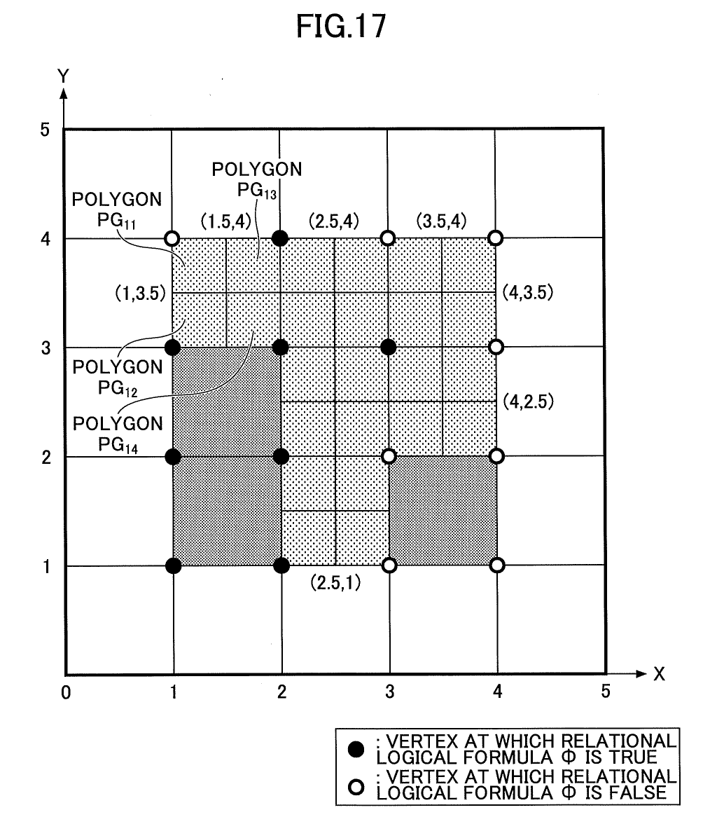

That is, in a case where at least one vertex of each of the vertices of a polygon differs in a value of the relational logical formula Φ(L,E), the polygon dividing unit 154 divides the polygon into smaller polygons. For example, as illustrated in FIG. 17, the values of the relational logical formula Φ(L,E) at the respective vertices of the polygon PG₁ are Φ(1,4)=false, Φ(1,3)=true, Φ(2,3)=true, and Φ(2,4)=true. Accordingly, in this case, the polygon dividing unit 154 divides the polygon PG₁ into a polygon PG₁₁, a polygon PG₁₂, a polygon PG₁₃, and a polygon PG₁₄. A similar process is applied to each of the polygon PG₂ to the polygon PG₉.

Then, the visualization library generation processing unit 150 returns to step S13. That is, the visualization library generation processing unit 150 causes the polygon dividing unit 154 to perform a polygon division the predetermined number of times.

Note that although the polygon dividing unit 154 divides each polygon, of which the value of the relational logical formula Φ(L,E) for at least one vertex of each of the vertices of the polygon differs, into four in the example illustrated in FIG. 17, the polygon dividing unit 154 is not required to divide a polygon into four. For example, the polygon dividing unit 154 may divide a polygon into eight polygons or sixteen polygons.

In a case where visualization library generation processing unit 150 determines that a polygon division has been performed for the predetermined number of times (YES in step S14), the polygon deforming unit 155 deforms in step S16 each polygon in accordance with the value of each vertex determined by the vertex determining unit 153.

That is, the polygon deforming unit 155 deforms each polygon into a polygon having, as the sides, straight lines that connect vertices of which the values of the relational logical formula Φ(L,E) are true.

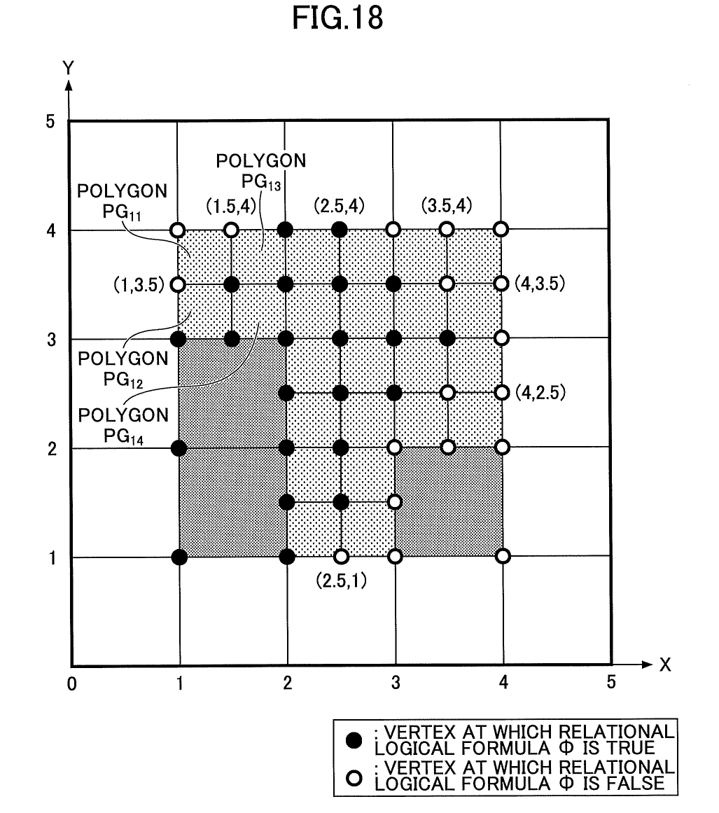

For example, as illustrated in FIG. 18, the values of Φ at the respective vertices (1,4), (1,3.5), (1.5,3.5), and (1.5,4) of the polygon PG₁₁ are respectively false, false, true, and false. Similarly, the values of Φ at the respective vertices (1,3.5), (1,3), (1.5,3), and (1.5,3.5) of the polygon PG₁₂ are respectively false, true, true, and true. The values of Φ at the respective vertices of the polygon PG₁₃ and the polygon PG₁₄ are as illustrated in FIG. 18.

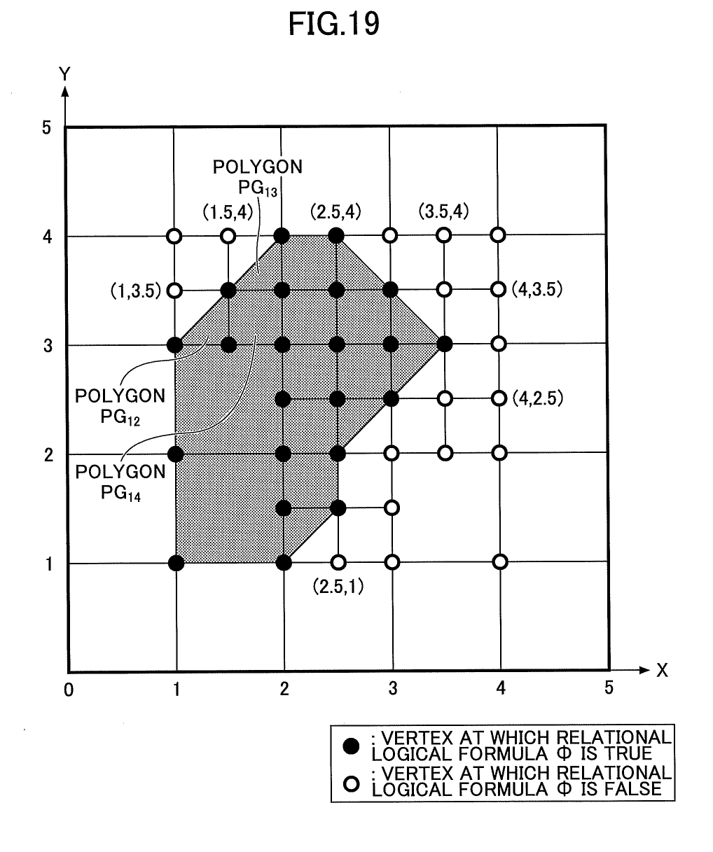

In this case, as illustrated in FIG. 19, the polygon deforming unit 155 deletes the polygon PG₁₁ of which the number of vertices whose values of Φ are true is only one. Further, as illustrated in FIG. 19, the polygon deforming unit 155 deforms each of the polygon PG₁₂ to the polygon PG₁₄ into a polygon having, as the sides, straight lines that connect vertices of which the values of the relational logical formula Φ(L,E) are true.

Note that although the polygon deforming unit 155 deforms polygons by straight lines connecting vertices, of which the values of Φ are true, in the example illustrated in FIG. 19, the polygon deforming unit 155 is not required to connect the vertices with straight lines. For example, the polygon deforming unit 155 may deform polygons by curved lines connecting vertices, of which the values of Φ are true.

Next, in step S17, the polygon data generating unit 156 generates polygon data that represents coordinates of each vertex of the polygons deformed by the polygon deforming unit 155.

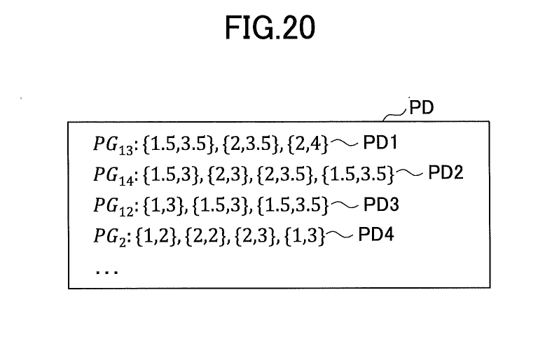

That is, for example, as illustrated in FIG. 19, the polygon deforming unit 155 has deformed respective polygons into polygons such as the polygon PG₁₂ the polygon PG₁₃, and the polygon PG₁₄. In this case, the polygon data generating unit 156 generates the polygon data PD that represents the coordinates of the vertices of each of the polygons as illustrated in FIG. 20.

The polygon data PD illustrated in FIG. 20 includes polygon data PD1 includes polygon data PD1 that represents the coordinates of each of the vertices of the polygon PG₁₃ and polygon data PD2 that represents the coordinates of each of the vertices of the polygon PG₁₄. Similarly, the polygon data PD illustrated in FIG. 20 includes polygon data PD3 includes polygon data PD1 that represents the coordinates of each of the vertices of the polygon PG₁₂ and polygon data PD4 that represents the coordinates of each of the vertices of the polygon PG₂. In other words, the polygon data generating unit 156, which is an example of a depicting data generating unit, may generate, based on a relational logical formula that represents a relationship between a plurality of variables to be analyzed generated by the quantifier eliminating unit 140, polygon data as depicting data for depicting, in a coordinate system with the variables as respective coordinate axes, an area that satisfies the relational logical formula.

Next, in step S18, the visualization library generating unit 157 generates a visualization library V that includes the polygon data generated by the polygon data generating unit 156. For example, the visualization library V may be a program code in which the polygon data PD is described in accordance with a description method of a programing language such as Python.

Note that the visualization library generating unit 157 may also being able to generate a visualization library V that includes a program code that is executed to generate the polygon data. That is, the visualization library generating unit 157 may also being able to generate a visualization library V that includes a program code for executing the process of steps S11 to S17 illustrated in FIG. 14. In other words, the visualization library generating unit 157 may also being able to generate a visualization library V that includes a program code for executing the generation range setting unit 151, the polygon generating unit 152, the vertex determining unit 153, the polygon dividing unit 154, the polygon deforming unit 155, and the polygon data generating part 156. According to such a configuration, as illustrated in FIG. 8, processes that require time such as generating the first-order predicate logic formula and the quantifier elimination method are executed before generating the visualization library V, for example. Thereby, the visualization library V is not required to include software for mathematical processes, and it is possible to generate polygon data (depicting data) at high speed.

In this way, the visualization library generating unit 157 generates a visualization library V that includes the polygon data generated by the polygon data generating unit 156 or generates a visualization library V that generates the polygon data.

As described above, according to the operation support system 1 of the first embodiment, it is possible to cause the offline analyzing unit 100 of the support apparatus 10 to generate, based on the input demand-supply system model M, the input facility-capacity information C, and the input analysis condition information D, the visualization library V for depicting the executable area R.

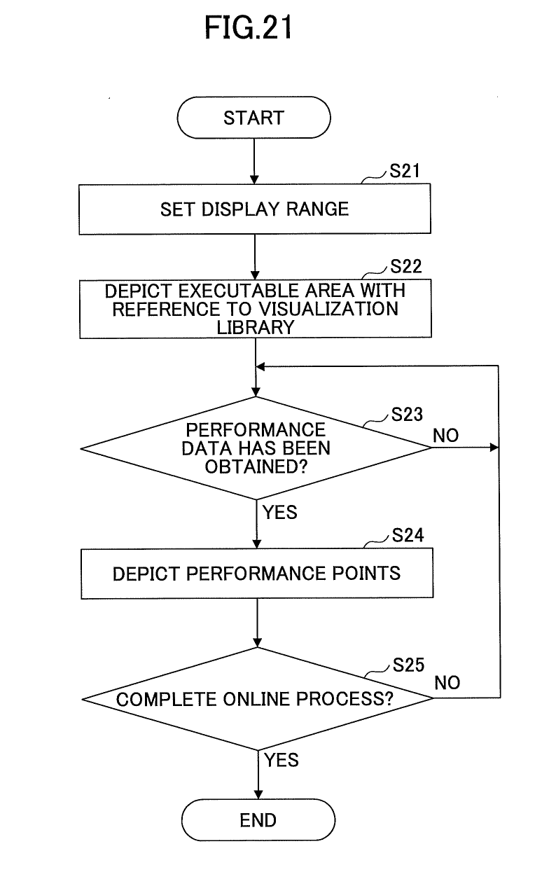

Next, a process executed by the online visualizing unit 200 to depict an executable area R and performance points Q will be described with reference to FIG. 21. FIG. 21 is a flowchart illustrating an example of the process executed by the online visualizing unit 200.

First, in step S21, the display range setting unit 210 sets a display range of the executable area R. For example, the display range may be set by a user designating a range the executable area R to be displayed on the display device 12. For example, the user may set the display range via the input device 11.

Next, in step S22, the executable area depicting unit 220 depicts the executable area R based on the visualization library V generated by the visualization library generating unit 157. That is, for example, with reference to the visualization library V, the executable area depicting unit 220 depicts, in the coordinate system where the horizontal axis and the vertical axis respectively correspond to the “total demanded quantity L” and the “total cost E”, the polygons defined by the polygon data PD included in the visualization library V.

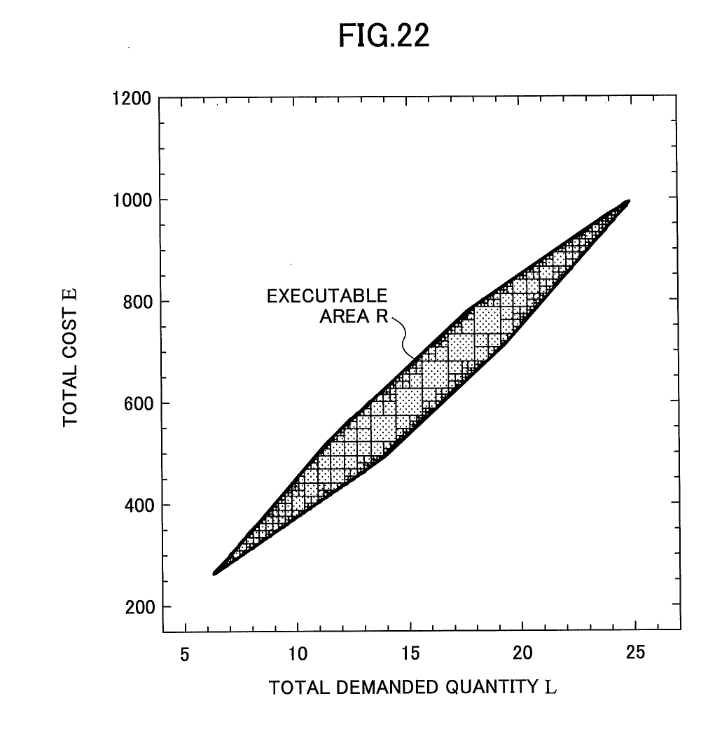

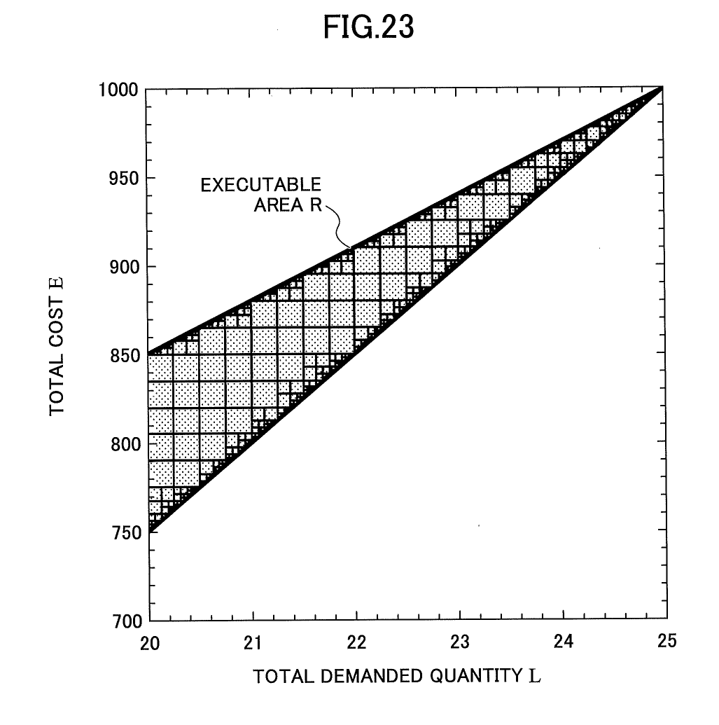

Here, FIG. 22 illustrates an example of the executable area R depicted in the coordinate system in which the horizontal axis and the vertical axis respectively correspond to the “total demanded quantity L” and the “total cost E”. In FIG. 22, a plurality of polygons are depicted to depict the executable area R. Further, FIG. 23 illustrates another example of the executable area R in a case where a display range differing from that in FIG. 22 is set.

As illustrated in FIG. 22 and FIG. 23, because the executable area R is depicted by the plurality of polygons, even when the display range is narrowed (that is, even when the executable area R is enlarged and displayed), the executable area R is accurately depicted without a grainy boundary.

Next, in step S23, the performance point depicting unit 230 determines whether performance data P measured by the performance measuring unit 300 of the measurement apparatus 20 during an operation of the demand-supply system has been obtained.

In a case where the performance point depicting unit 230 does not determine that performance data P has been obtained, (NO in step S23), the online visualizing unit 200 returns to the process of step S23.

In a case where the performance point depicting unit 230 determines that performance data P has been obtained, (YES in step S23), the performance point depicting unit 230 depicts in step S24 performance points Q, represented by the performance data P, in the coordinate system in which the horizontal axis and the vertical axis respectively correspond to the “total demanded quantity L” and the “total cost E”.

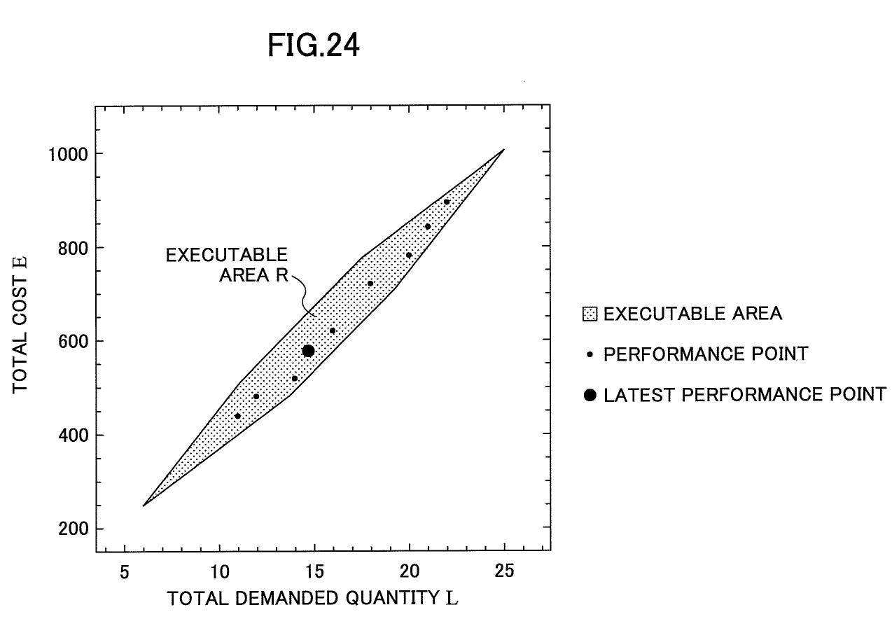

Here, an example of the executable area R and the performance points Q are illustrated in FIG. 24. As illustrated in FIG. 24, the executable area R and the performance points Q are depicted in the same coordinate system. Thereby, the user of the support apparatus 10 can know (view) a relationship between the executable area R and the performance points Q, which represent performance of the demand-supply system. Further, among the depicted performance points Q, the performance point Q depicted most recently may be highlighted. The performance point Q may be highlighted by enlarging it, displaying it in visible color, blinking it, or the like, for example. Note that in the example illustrated in FIG. 24, the executable area R obtained by removing the boundary of each polygon is illustrated.

Next, in step S25, the online completion determining unit 240 determines whether to complete an online process. For example, when the user performs an operation to complete the online process, the online completion determining unit 240 determines to complete the online process (YES in step S25).

In a case where the online completion determining unit 240 does not determine to complete the online (NO in step S25), the online visualizing unit 200 returns to the process of step S23.

In a case where the online completion determining unit 240 determines to complete the online (YES in step S25), the online visualizing unit 200 completes the online. That is, in this case, the online visualizing unit 200 completes drawing the performance points Q of the demand-supply system, for example.

As described above, according to the operation support system 1 of the first embodiment, the executable area R can be depicted based on the visualization library V and the performance points Q can be depicted based on the performance data P. When depicting the executable area R, the support apparatus 10 can depict the executable area R at high speed by using the visualization library V without executing process that require time such as generating a first-order predicate logic formula and a quantifier elimination method, for example.

Hence, during an online operation of the operation support system, the support apparatus 10 can depict at high speed the executable area R that represents the relationship between the total demanded quantity L and the total cost E that can be taken by the demand-supply system. Accordingly, the user of the support apparatus 10 becomes able to confirm (view), on the same screen, the performance points Q that represent the performances of the total demanded quantity L and the total cost E of the demand-supply system and the executable area R, and becomes able to operational consideration in consideration of the daily performances of operation of the demand-supply system.

### Second Embodiment

Next, a second embodiment will be described. According to the second embodiment, a case will be described in which the offline analyzing unit 100 and the online visualizing unit 200 operate in different information processing apparatuses (computers). In the descriptions of the second embodiment, differences between the second embodiment and the first embodiment will be mainly described. Note that descriptions of elements and operations of the second embodiment similar to those of the first embodiment will be omitted as appropriate.

### <System Configuration>

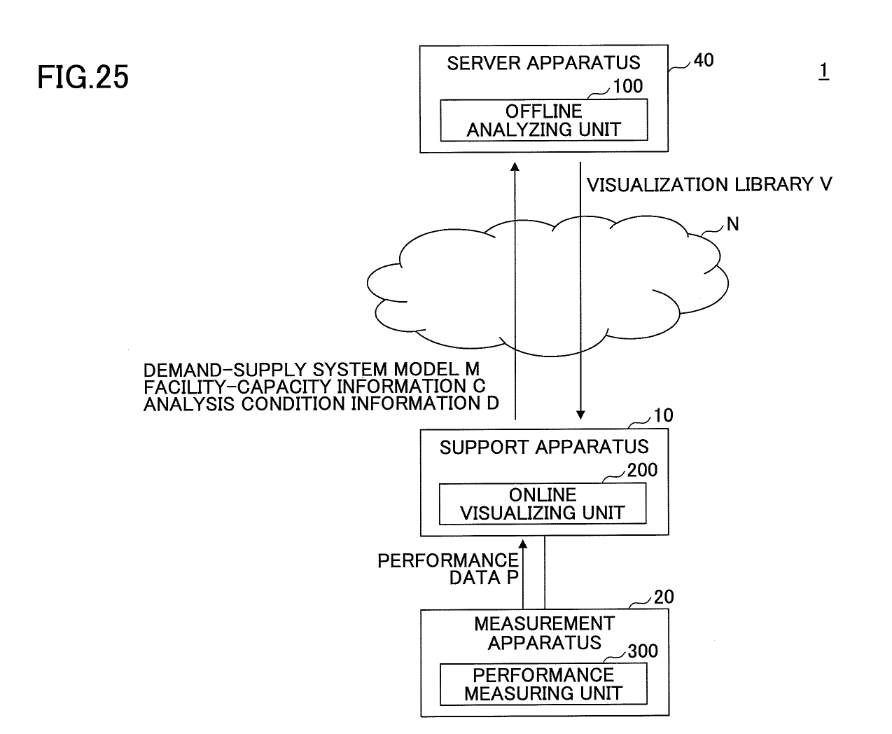

In the following, a configuration of an operation support system 1 according to the second embodiment will be described with reference to FIG. 25. FIG. 25 is a block diagram illustrating an example of a configuration of the operation support system 1 according to the second embodiment.

As illustrated in FIG. 25, the operation support system 1 according to the second embodiment further includes a server apparatus 40. Further, according to the second embodiment, the support apparatus 10 and the sever apparatus 40 are communicably connected via a wide area network N such as the Internet.

For example, the server apparatus 40 is an information processing apparatus such as a computer, and includes the offline analyzing unit 100. The support apparatus according to the second embodiment includes the online visualizing unit 200.

For example, the offline analyzing unit 100 of the server apparatus 40 according to the second embodiment generates a visualization library V based on a demand-supply system model M, facility-capacity information C, and analysis condition information obtained from the support apparatus 10 according to the second embodiment.

Further, the online visualizing unit 200 of the support apparatus 10 according to the second embodiment depicts, based on the visualization library V obtained from the server apparatus 40 and based on performance data P obtained from the measurement apparatus 20, an executable area R and at least one performance point Q represented by the performance data P.

As described above, differing from the first embodiment, the support apparats 10 according to the second embodiment is not required to include the offline analyzing unit 100. Accordingly, for example, even when a program that realizes the offline analyzing unit 100 is not installed in the support apparatus 10, a user of the support apparatus 10 becomes able to consider the operation in consideration of the daily performances of operation of the demand-supply system.

### Third Embodiment

Next, a third embodiment will be described. According to the third embodiment, another example case will be described in which the offline analyzing unit 100 and the online visualizing unit 200 operate in different information processing apparatuses (computers).

In the descriptions of the third embodiment, differences between the third embodiment and the second embodiment will be mainly described. Note that descriptions of elements and operations of the third embodiment similar to those of the second embodiment will be omitted as appropriate.

<System Configuration>

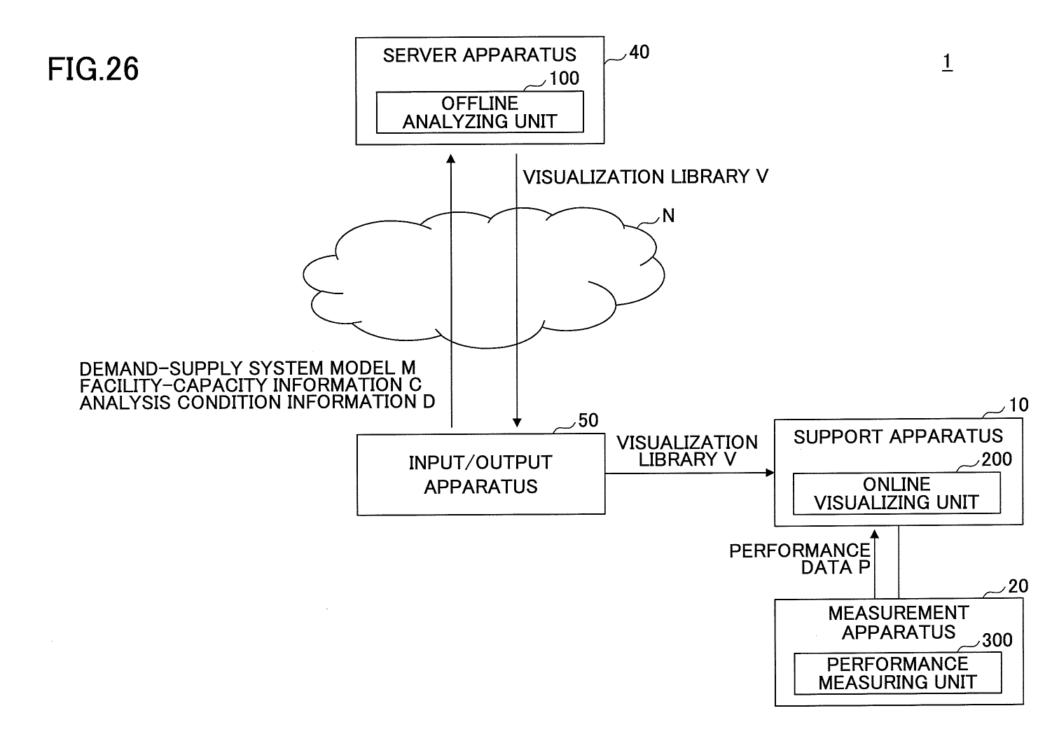

In the following, a configuration of an operation support system 1 according to the third embodiment will be described with reference to FIG. 26. FIG. 26 is a block diagram illustrating an example of a configuration of the operation support system 1 according to the third embodiment.

As illustrated in FIG. 26, the operation support system 1 according to the third embodiment further includes an input/output apparatus 50. Further, the sever apparatus 40 and the input/output apparatus 50 are communicably connected via the network N. Here, the support apparatus 10 according to the third embodiment is not required to be communicably connected via the network.

For example, the input/output apparatus 50 is an information processing apparatus such as a computer. Note that the input/output apparatus 50 may have an input apparatus and an output apparatus (such as a display, a keyboard, and a mouse, for example) that can perform communication with the server apparatus 40 via the network N. According to the third embodiment, the user uses the input/output apparatus 50 to create a demand-supply system model M, facility-capacity information C, and analysis condition information D.

The offline analyzing unit 100 of the server apparatus 40 according to the third embodiment generates a visualization library V based on the demand-supply system model M, the facility-capacity information C, and the analysis condition information D obtained from the input/output apparatus 50, for example. Then, the server apparatus 40 provides the generated visualization library V to the input/output apparatus 50.

Further, the online visualizing unit 200 of the support apparatus 10 according to the third embodiment depicts, based on the visualization library V obtained from the input/output apparatus 50 and based on performance data P obtained from the measurement apparatus 20, an executable area R and at least one performance point Q represented by the performance data P.

Here, the support apparatus 10 according to the third embodiment may be directly coupled to the input/output apparatus 50 via a USB cable to obtain the visualization library V or may obtain the visualization library V via the network N, for example. The support apparatus 10 according to the third embodiment may obtain the visualization library V from the input/output apparatus 50 via a recording medium such as a USB memory, for example.

In this way, differing from the first embodiment and the second embodiment, the support apparatus 10 according to the third embodiment obtains the visualization library V from the input/output apparatus 50. Accordingly, for example, even when the support apparatus 10 is installed in a location that cannot be coupled to the network N, a user of the support apparatus 10 according to the third embodiment becomes able to consider an operation in consideration of daily performances of operation of the demand-supply system.

The present invention is not limited to the specifically described embodiments, but various variations and modifications may be made without departing from the scope of the present invention.

For example, functional elements of each apparatus described above may be realized by a memory that stores at least one program and a processor coupled to the memory. Further, at least one program for causing each apparatus described above to execute a process as described above may be stored in a computer-readable recording medium.

The present application is based on and claims the benefit of priority of Japanese Priority Application No. 2016-256236 filed on Dec. 28, 2016, the entire contents of which are hereby incorporated by reference.

What is claimed is:

1. An operation support apparatus for supporting an operation of a demand-supply system, the demand-supply system including a resource supplying facility configured to supply a resource, a resource demander facility configured to demand the resource supplied from the resource supplying facility, and a supply path of the resource, the operation support apparatus comprising:
an input unit configured to input a demand-supply system model of the demand-supply system, facility-capacity information that represents a facility capacity of the resource supplying facility and the supply path, and analysis condition information in which a plurality of variables to be analyzed with respect to the demand-supply system model and the facility-capacity information are defined;
a logical formula generating unit configured to generate, based on the demand-supply system model, the facility-capacity information, and the analysis condition information input by the input unit, a relational logical formula that represents a relationship between the plurality of variables;
a depicting data generating unit configured to generate, based on the relational logical formula generated by the logical formula generating unit, depicting data for depicting, in a coordinate system with the plurality of variables as respective coordinate axes, an area that satisfies the relational logical formula;
a visualization library generating unit configured to generate a visualization library that includes the depicting data generated by the depicting data generating unit or a visualization library that includes the depicting data generating unit to generate the depicting data on demand; and
an online visualizing unit configured to depict, based on the visualization library generated by the visualization library generating unit and performance data of the demand-supply system obtained from a measurement apparatus coupled to the operation support apparatus, the area and a performance point represented by the performance data in the coordinate system.

2. The operation support apparatus according to claim 1,
wherein the logical formula generating unit generates, based on the demand-supply system model, the facility-capacity information, and the analysis condition information input by the input unit, a mathematical formula set that includes a plurality of mathematical formulas that represent an objective variable and constraint conditions in an optimization problem of the demand-supply system,
wherein the logical formula generating unit generates a first-order predicate logic formula based on the generated mathematical formula set, and
wherein the logical formula generating unit generates, based on the generated first-order predicate logic formula, the relational logical formula that represents the relationship between the plurality of variables by using a quantifier elimination method.

3. The operation support apparatus according to claim 1, wherein the visualization library includes a program code that is executed to generate the depidting data or includes the depicting data generated by the depicting data generating unit.

4. The operation support apparatus according to claim 3, wherein the depicting data is polygon data that defines a polygon for depicting the area.

5. The operation support apparatus according to claim 4, further comprising:
a determining unit configured to determine whether a value of the relational logical formula at each vertex of the polygon is true or false in a predetermined range of the coordinate system,
wherein the depicting data generating unit is configured to generate the polygon data based on the value of the relational logical formula at each vertex of the polygon determined by the determining unit.

6. The operation support apparatus according to claim 5, further comprising:
a polygon dividing unit configured to divide, based on the value of the relational logical formula at each vertex of the polygon determined by the determining unit, the polygon that has both values of the relational logical formula that are true and false into polygons in the predetermined range of the coordinate system,
wherein the determining unit determines whether a value of the relational logical formula at each vertex of the divided polygons unit is true or false.

7. The operation support apparatus according to claim 6,
wherein the polygon dividing unit divides the polygon, based on the value of the relational logical formula at each vertex of the polygon determined by the determining unit, in a case where not every value of the relational logical formula in the polygon is true or not every value of the relational logical formula in the polygon is false.

8. The operation support apparatus according to claim 6, further comprising:
a polygon deforming unit configured to deform, in a case where the polygon is divided by the polygon dividing unit for a predetermined number of times, the polygons divided by the polygon dividing unit based on the value of the relational logical formula determined by the determining unit into polygons having, as sides, straight lines that connect vertices of the polygons of which values of the relational logical formula are true,
wherein the depicting data generating unit generates polygon data that defines the polygons deformed by the deforming unit.

9. An operation support system comprising:
an operation support apparatus configured to support an operation of a demand-supply system, the demand-supply system including a resource supplying facility configured to supply a resource, a resource demander facility configured to demand the resource supplied from the resource supplying facility, and a supply path of the resource; and
an information processing apparatus,
wherein the information processing apparatus includes
an input unit configured to input a demand-supply system model of the demand-supply system, facility-capacity information that represents a facility capacity of the resource supplying facility and the supply path, and analysis condition information in which a plurality of variables to be analyzed with respect to the demand-supply system model and the facility-capacity information are defined,
a logical formula generating unit configured to generate, based on the demand-supply system model, the facility-capacity information, and the analysis condition information input by the input unit, a relational logical formula that represents a relationship between the plurality of variables,
a depicting data generating unit configured to generate, based on the relational logical formula generated by the logical formula generating unit, depicting data for depicting, in a coordinate system with the plurality of variables as respective coordinate axes, an area that satisfies the relational logical formula, and
a visualization library generating unit configured to generate a visualization library that includes the depicting data generated by the depicting data generating unit or a visualization library that includes the depicting data generating unit to generate the depicting data on demand,
wherein the operation support apparatus includes an online visualizing unit configured to depict, based on the visualization library generated by the visualization library generating unit and performance data of the demand-supply system obtained from a measurement apparatus coupled to the operation support apparatus, the area and a performance point represented by the performance data in the coordinate system.

10. The operation support system according to claim 9,
wherein the operation support apparatus and the information apparatus are coupled communicably via a network, and
wherein the online visualizing unit depicts the area and the performance point in the coordinate system based on the visualization library and the performance data received from the information processing apparatus via the network.

11. An information processing apparatus that is coupled to an operation support apparatus for supporting an operation of a demand-supply system, the demand-supply system including a resource supplying facility configured to supply a resource, a resource demander facility configured to demand the resource supplied from the resource supplying facility, and a supply path of the resource, the information processing apparatus comprising:
an input unit configured to input a demand-supply system model of the demand-supply system, facility-capacity information that represents a facility capacity of the resource supplying facility and the supply path, and analysis condition information in which a plurality of variables to be analyzed with respect to the demand-supply system model and the facility-capacity information are defined;
a logical formula generating unit configured to generate, based on the demand-supply system model, the facility-capacity information, and the analysis condition information input by the input unit, a relational logical formula that represents a relationship between the plurality of variables;
a depicting data generating unit configured to generate, based on the relational logical formula generated by the logical formula generating unit, depicting data for depicting, in a coordinate system with the plurality of variables as respective coordinate axes, an area that satisfies the relational logical formula; and
a visualization library generating unit configured to generate a visualization library that includes the depicting data generated by the depicting data generating unit or a visualization library for generating the depicting data.

12. An operation support apparatus that is coupled to an information processing apparatus configured to generate a visualization library for generating depicting data for depicting, in a coordinate system with a plurality of variables as respective coordinate axes, an area that satisfies a relational logical formula that represents the relationship between a plurality of variables or generate a visualization library including the depicting data, the operation support apparatus comprising:
an obtaining unit configured to obtain the visualization library from the information processing apparatus; and
an online visualizing unit configured to depict, based on the visualization library obtained by the obtaining unit and performance data of a demand-supply system obtained from a measurement apparatus coupled to the operation support apparatus, the area and a performance point represented by the performance data in the coordinate system.

13. The operation support apparatus according to claim 12, further comprising:
a transmitting unit configured to transmit, to the information processing apparatus that generates the relational logical formula that represents the relationship between the plurality of variables based on a demand-supply system model of the demand-supply system, facility-capacity information that represents a facility capacity of a resource supplying facility and a supply path, and analysis condition information in which the plurality of variables to be analyzed with respect to the demand-supply system model and the facility-capacity information are defined, the analysis condition information.
